(19) United States
(12) Patent Application Publication
(10) Pub. No.: US 2007/0026798 A1
(43) Pub. Date: Feb. 1, 2007

(54) Message notification device

(75) Inventor: Corrie A. Hoogstra, Bethesda, MD (US)

Correspondence Address: SPRINT NEXTEL CORPORATION, 6391 SPRINT PARKWAY, MAILSTOP: KSOPHT0101-Z2100, OVERLAND PARK, KS, 66251-2100, US

(73) Assignee: NEXTEL COMMUNICATIONS, INC., Reston, VA (US)

(21) Appl. No.: 11/192,119

(22) Filed: Jul. 29, 2005

(51) Int. Cl. H04B 7/00

(52) U.S. Cl. 455/41.2; 455/567

(57) ABSTRACT

A device and method for notifying a user of a mobile communication device that a communication has been received from a wireless macro network are provided. The message notification device communicates with the mobile communication device through a short-range wireless communication link, and can be worn on the body of the user as, for example, a bracelet worn around the wrist, or a pendant worn around the neck. The message notification device contains a mechanism, such as vibration device, to alert the user of an incoming communication, and may contain a display on which information associated with the incoming communication can be shown.

### BACKGROUND OF THE INVENTION

For many people mobile communication devices have become indispensable. In order to communicate with other mobile and fixed communication devices, these devices use radio frequency signals to communicate with a wireless macro network. The wireless macro network includes multiple interconnected base stations, which communicate with mobile communication devices using radio frequency signals. Typically, mobile communication devices communicate with a base station over a distance of thousands of feet to several miles utilizing spectrum allocated by government bodies, frequently referred to as licensed spectrum. A wireless macro network can allow communication between mobile communication devices using base stations, and can use the public switched telephone network (PSTN), or other external networks, to deliver communications to users that are not directly connected to the wireless macro network.

Mobile communication devices often use an audible alert to notify the user of an incoming communication from another user. Although this may be acceptable for most users, it is often inadequate for users in harsh environments, such as construction and industrial sites where workers are subjected to loud noise levels that prevent them from hearing audible message notifications. In addition, often in these environments workers need to wear protective headgear, which not only further limits the use of audible notifications, but prevents the use of a headset with the mobile communication device.

Some mobile communication devices contain a vibration device to alert a user of an incoming communication. However, workers in harsh environments often need to wear thick protective outer clothing, which limits the effectiveness of a vibratory alert because the vibrating device cannot be felt through the thick clothing, which dampens the vibration.

An additional problem in various work environments is that the quality of the received signal from a base station can vary, for example, within a building, and can even vary considerably, for example, within a particular room within a building. If a user happens to be standing in a part of a room where the quality of the signal received by the wireless communication device is poor, the user may not receive the incoming communication.

### SUMMARY OF THE INVENTION

The present invention overcomes the above-identified and other deficiencies of conventional mobile communication devices. In particular, a device and method is disclosed for notifying a user of a communication received by a mobile communication device from a wireless macro network, in particular for instance where the audible alert of the mobile communication device cannot be very well heard, and/or where the vibratory alert of the mobile communication device cannot be very well felt.

In accordance with the present invention, the mobile communication device communicates with a message notification device that can be worn by the user, and notifies the user of incoming communications from the wireless macro network. This message notification device may be, for example, in the form of a bracelet that is worn around the wrist or ankle, a pendant that is worn around the neck, a ring worn around a finger, etc., and contains a vibration alert device for message alert notification. Because the message notification device is worn close to, or on, the body and under any heavy protective clothing that the user might be wearing, the vibration device can be readily felt by the user.

The mobile communication device communicates with the message notification device using a short-range wireless communication link. Because the mobile communication device and the message notification device are typically less than 1 ft to at most several 100 ft apart, transmission power can be much lower than the transmission power required for communication between the mobile communication device and the wireless macro network. The low transmission power allows the use of unlicensed spectrum for the short-range wireless link, and allows for better battery life of the message notification device. Suitable wireless communication protocols for use as the short-range wireless communication link include, for example, 802.11a, 802.11b, 802.11g, Bluetooth, or similar proprietary and/or non-proprietary and short-range wireless communication protocols.

Other objects, advantages and novel features of the present invention will become apparent from the following detailed description of the invention when considered in conjunction with the accompanying drawings.

### BRIEF DESCRIPTION OF THE DRAWING FIGURES

FIG. 1a is a diagram of an exemplary message notification device contained in a enclosure that is worn on the wrist in accordance with the present invention;

FIG. 1b is a diagram showing a cross-sectional view of the exemplary message notification device of FIG. 1a;

FIG. 2 is a diagram of an exemplary message notification device contained in a enclosure that is worn around the neck as a pendant in accordance with the present invention;

FIG. 3 is a block diagram of an exemplary message notification device in accordance with the present invention; and

FIG. 4 is a flow diagram illustrating an exemplary method of alerting a user of an incoming communication received from a wireless macro network in accordance with the present invention.

### DETAILED DESCRIPTION OF THE PREFERRED EMBODIMENTS

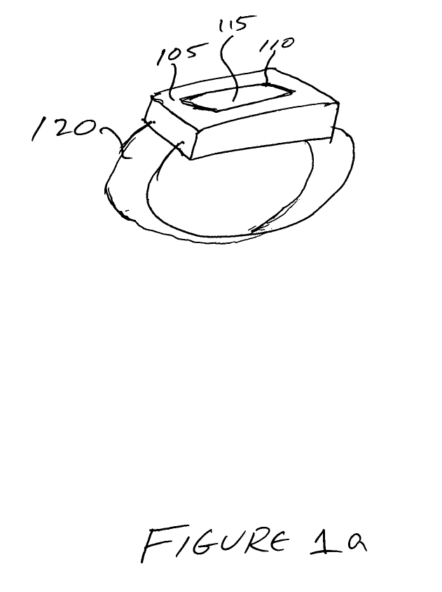

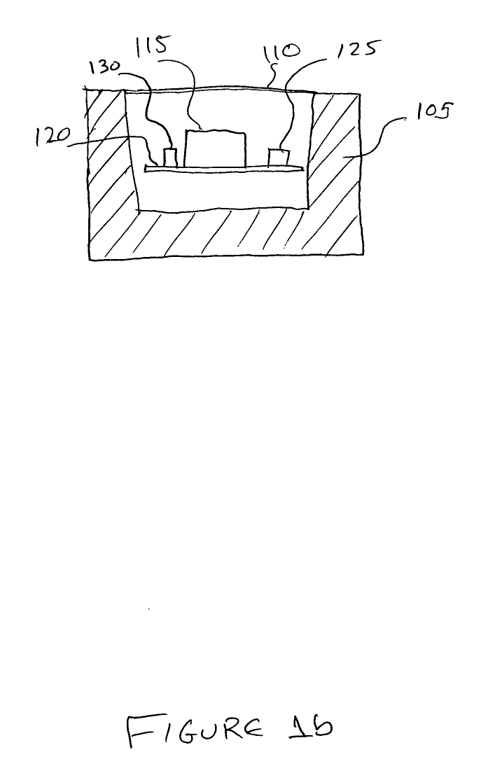

FIG. 1a is a diagram of an exemplary message notification device contained in a enclosure that is worn on the wrist in accordance with the present invention. Enclosure 105 contains all the electronic components of the message notification device. Strap 120 allows the device to be secured to the user's wrist. Display 115 may be viewed by the user while wearing the device.

FIG. 1b is a diagram showing a cross-sectional view of the enclosure 105 of the exemplary message notification device of FIG. 1a. Electronic components such as vibration device 130, audio alert device 125, and display device 115 may be mounted on a circuit board 120. Seal 110 may allow for the message notification device to be water resistant. Of course, it can also be designed to be shock resistant as well in a conventional manner.

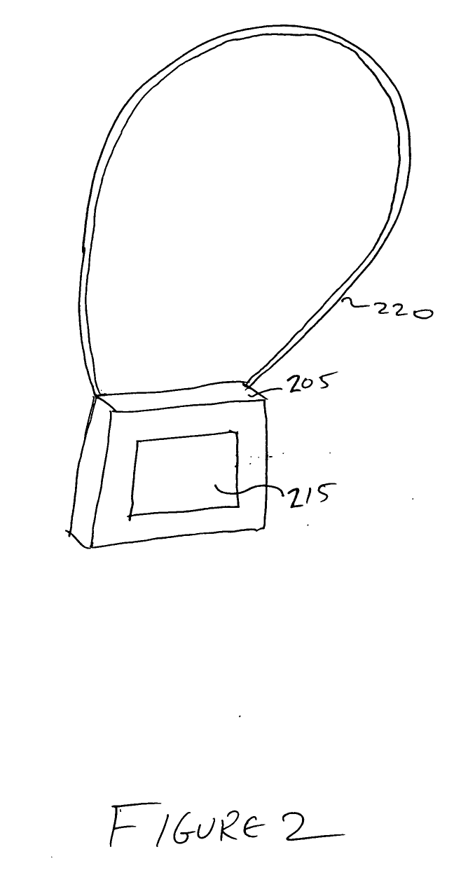

FIG. 2 is a diagram of a further exemplary message notification device contained in a enclosure that is worn around a person's neck in a pendant manner in accordance with the present invention. Enclosure 205 contains all of the electronic components of the message notification device similar to enclosure 105 in FIG. 1. Necklace 220 allows the device to be worn around the user's neck. The necklace may be, for example, made of any form, conventionally used as a pendant or necklace. Display 215 can be viewed by the user while wearing the device. The message notification device of FIG. 2 can include the elements described above in connection with FIG. 1b.

FIGS. 1 and 2 are merely exemplary configurations of the disclosed invention. Other configurations can be envisioned such as message notification devices that are strapped to the user's ankle, or worn on the user's finger like a ring.

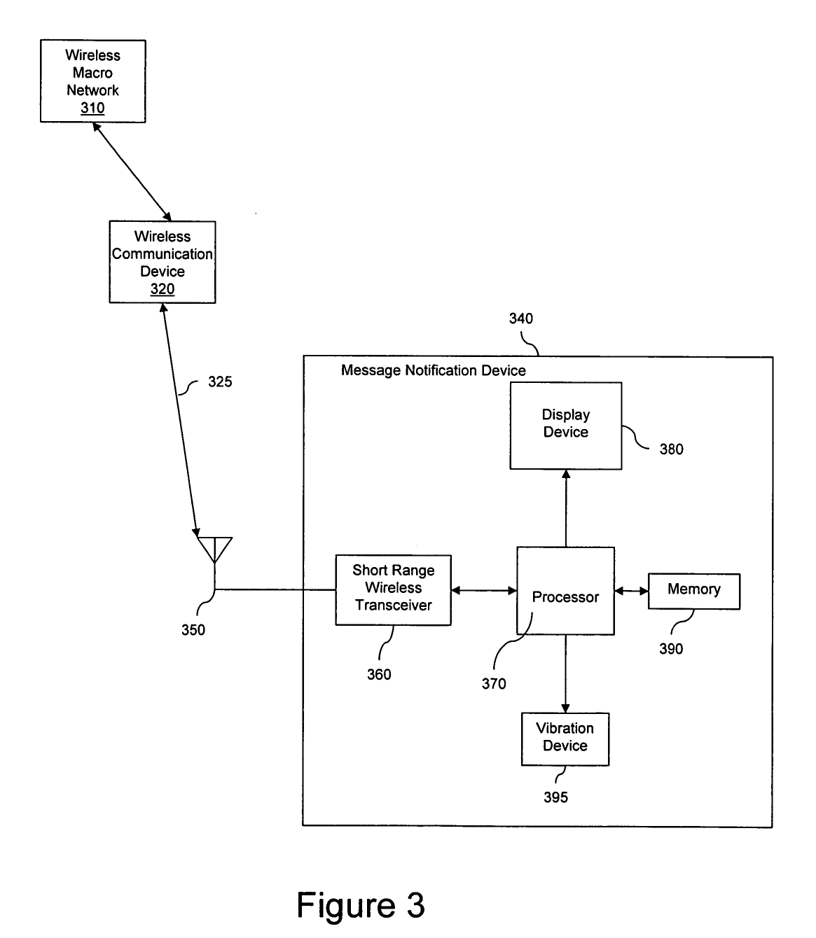

FIG. 3 is a block diagram of an exemplary system with a message notification device in accordance with the present invention. Message notification device 340 includes antenna 350, short-range wireless transceiver 360, processor 370, display device 380, memory 390 and vibration device 395. Processor 370 can be a microprocessor running program code, an application specific integrated circuit (ASIC), filed programmable gate array (FPGA) or the like.

Memory 390 is coupled to processor 370, and can be used for the storage of configuration information or storing a program for operating processor 370. Memory 390 can be random access memory, read only memory, flash memory, and/or the like.

The short-range wireless transceiver 360 uses antenna 350 to receive messages from wireless communications device 320 via a short-range wireless link 325 in response to wireless communication device 320 receiving a communication from wireless macro network 310. The antenna 350 can be any type of antenna. Although antenna 350 is illustrated as being located outside of message notification device 340, it can be enclosed within the device.

Suitable wireless communication protocols for use as the short-range wireless communication link include, for example, 802.11a, 802.11b, 802.11g, Bluetooth or similar proprietary and/or non-proprietary short-range wireless data protocols. Because mobile communication device 320 and the message notification device 340 are typically less than 1 ft to, at most, several 100 ft apart, transmission power requirements are much lower than the transmission power required for communication between the mobile communication device and the wireless macro network. The low transmission power allows unlicensed spectrum to be used for the short-range wireless link, and allows for better battery life for the message notification device.

When processor 370 receives an incoming message from the short-range wireless transceiver 360, processor 370 activates vibration device 395 to alert the user. The processor 370 also sends a message to the display device 380 to allow the user to display the details of the message, such as caller ID information, or a brief text message associated with the incoming communication from the wireless macro network 310.

The communications received by wireless communication device 320 from wireless macro network 310 can be a voice call, a Short Message Service (SMS) message, or other types of data. Additionally, or alternatively, the incoming communication can be a paging message indicating that there is an incoming voice or data call for the wireless communication device 320. In the case of a voice call, the wireless communication device 320 will typically send an alert to the wireless communication device 320 containing caller ID information, and other information related to the call. The message sent to the message notification device 340 can be a sub-set of the data contained in the communication sent by the wireless macro network 310 to the wireless communication device. In the case of an SMS message from the wireless macro network being received by the wireless communication device 320, the message sent by the wireless communication device 320 to the message notification device 340 may contain the actual text of the SMS message, or alternately may contain only a notification that an SMS message has been received.

A variety of technologies can be used for display device 380, such as Liquid Crystal Displays (LCD), Light Emitting Diodes (LED), or Organic Light Emitting Diodes (OLED). Because these display devices may be too small to display all of the text associated with the incoming message, the text can be horizontally or vertically scrolled across the screen to allow the user to see the entire text message. Additionally, or alternatively, an indicator, such as an LED, can flash or otherwise notify the user when there is an incoming message. In accordance with another embodiment, there may not be any visual notification, and instead the vibration device alerts the user. According to this embodiment, the display device 380 can be omitted from the message notification device 340.

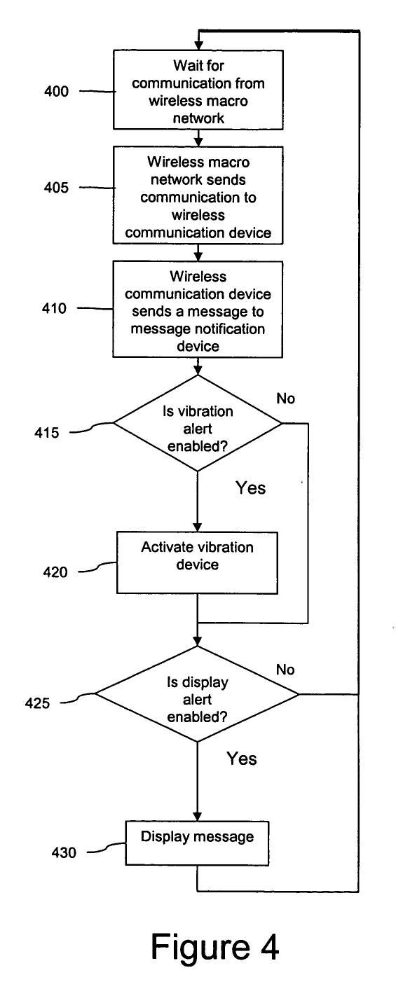

FIG. 4 is a flow diagram illustrating an exemplary method of alerting a user of a message received from a macro cell network in accordance with the present invention. Initially, the wireless communications device 320 waits for an incoming communication from the macro cell network 310 (step 400). When the wireless communications device 320 receives an incoming communication from the wireless macro network 310 (step 405), the wireless communications device 320 sends a message to message notification device 340 via short-range wireless link 330 (step 410).

Once a message is received by the message notification device, if the vibration alert function has been enabled (“Yes” path out of decision step 415), processor 370 of message notification device 340 activates vibration device 395 (step 420). When the vibration alert is not enabled (“No” path out of decision step 415), the vibration device 395 is not activated. Next, if display alert has been enabled (“Yes” path out of step 425), the message is sent to display device 380 so that the user can view the message (step 430). Once the message has been displayed, or if display alert is not enabled (“No” path out of step 425), the handling of the message is now complete and the wireless communications device again waits for an incoming communication from the wireless macro cell network (step 400).

Another advantage of the disclosed invention is that when wearing the message notification device, the user does not need to be in direct physical contact with the wireless communication device to receive a communication from the wireless macro network. This can be useful inside of buildings or other areas where the quality of the signal received from the wireless macro network is poor. The user can place the wireless communication device somewhere nearby where signal reception from the wireless macro network is good. The user wearing a message notification device can then walk into areas nearby where the received signal quality from the wireless macro network is poor, but still be able to receive a message indicating that a communication has been received from the wireless macro network as long as the message notification device and wireless communication device are close enough to be able to communicate through the short-range wireless link. In addition, the message notification device can be designed to alert the user through one its output devices, such as a vibration device, or an audio alert device when it can no longer communicate with the wireless communication device to ensure that communications from the wireless macro network are not missed. Audio alert devices can be speakers, piezo audio transducers or the like.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A message notification device for a wireless communication device, comprising:
a transceiver which is coupleable to the wireless communication device by a short-range wireless communication link;
a processor, coupled to the transceiver, that receives a message from the short-range wireless communications link; and
an output device, coupled to the processor, which indicates that the wireless communication device is receiving an incoming communication from a wireless macro network.

2. The message notification device of claim 1, wherein the output device is a vibration device.

3. The message notification device of claim 1, wherein the output device is a display device that displays at least a portion of the message.

4. The message notification device of claim 3, wherein the display device comprises an LCD display, an LED display or an OLED display.

5. The message notification device of claim 1, wherein the received message indicates that the incoming communication is a voice call.

6. The message notification device of claim 1, wherein the received message indicates that the incoming communication is a short message service (SMS) message.

7. The message notification device of claim 1, wherein the received message includes text of a short message service (SMS) message that was contained in the incoming communication.

8. The message notification device of claim 1, further comprising:
an enclosure that contains the transceiver, the processor, and the output device;
wherein the enclosure is configured to be secured to a user.

9. The message notification device of claim 8, further comprising a strap, coupled to the enclosure, that fastens the enclosure to a user's wrist.

10. The message notification device of claim 8, wherein the enclosure has one or more water resistant seals.

11. The message notification device of claim 8, further comprising a necklace, coupled to the enclosure, that is worn around the user's neck.

12. The message notification device of claim 11, wherein the enclosure has a one or more water resistant seals.

13. The message notification device of claim 1, wherein the short-range wireless communication link is a radio frequency short-range communication link.

14. The message notification device of claim 13, wherein the short-range radio frequency communication link comprises an 802.11a, 802.11b, 802.11g, or a Bluetooth communication link.

15. The message notification device of claim 1, further comprising an audio alert device coupled to the processor.

16. The message notification device of claim 1, wherein the output device indicates when the message notification device cannot communicate with the wireless communication device.

17. A method for notifying a user of the reception of a message, the method comprising the acts of:
receiving a message from a wireless communication device over a short-range wireless communication link; and
outputting an alert when the message is received,
wherein the message indicates that the wireless communication device is receiving an incoming communication from a wireless macro network.

18. The method of claim 17, wherein the short-range wireless communication link is a radio frequency communication link.

19. The method of claim 18, wherein the short-range communication link comprises an 802.11a, 802.11b, 802.11g, or a Bluetooth communication link.

20. The method of claim 17, further comprising an audio alert device coupled to the processor.

21. The method of claim 17, wherein the output device indicates when the message notification device cannot communicate with the wireless communication device.

22. The method of claim 17, wherein the alert activates a vibrating device.

23. The method of claim 17, wherein the alert is output to a display.

24. The method of claim 23, wherein the display device comprises an LCD display, an LED display or an OLED display.

25. The method of claim 17, wherein the received message indicates that the incoming communication is a voice call.

26. The method of claim 17, wherein the received message indicates that the incoming communication is a short message service (SMS) message.

27. The method of claim 17, wherein the received message includes text of a short message service (SMS) message that was contained in the incoming communication.

28. The method of claim 17, wherein the alert activates an audio alert device.
